(19) United States
(12) Patent Application Publication
(10) Pub. No.: US 2014/0368527 A1
(43) Pub. Date: Dec. 18, 2014

(54) VIDEO DISPLAY DEVICE AND TELEVISION RECEIVING DEVICE

(71) Applicants: Toshiyuki Fujine, Osaka-shi (JP); Yoji Shiraya, Osaka-shi (JP)

(72) Inventors: Toshiyuki Fujine, Osaka-shi (JP); Yoji Shiraya, Osaka-shi (JP)

(73) Assignee: SHARP KABUSHIKI KAISHA, Osaka-shi, Osaka (JP)

(21) Appl. No.: 14/373,735

(22) PCT Filed: Jul. 5, 2012
(86) PCT No.: PCT/JP2012/067221

§ 371 Date: Jul. 22, 2014

(30) Foreign Application Priority Data
Feb. 8, 2012 (JP) 2012-024726

(51) Int. Cl. G09G 5/10

(52) U.S. Cl. CPC G09G 5/10
USPC 345/589

(57) ABSTRACT

Areas of a video signal that represent light emission are detected, the luminance levels at which said light emission areas are displayed are enhanced, emphasizing said areas, and said luminance stretching is controlled in accordance with a set image quality mode, thereby producing consistently natural, high-quality visual imagery. A light emission detecting portion (12) counts pixels in order to generate a histogram of a prescribed feature quantity of an input video signal and identifies areas that fall within a prescribed range at the upper end of said histogram as being light emission areas. On the basis of a brightness-related index computed from the input video signal on the basis of prescribed conditions, an area-active-control/luminance-stretching portion (14) performs luminance stretching, increasing the luminance of a backlight portion (16) and reducing the luminance of non-light emission areas of the video signal, i.e. the areas other than the light emitting areas. When doing so, the area-active-control/luminance-stretching portion (14) switches between control curves, which define the relationship between the brightness-related index and the amount of stretching, in accordance with an image quality mode set by an image quality mode setting portion (19).

### TECHNICAL FIELD

The present invention relates to a video display device and a television receiving device, and more specifically to a video display device having a luminance stretching function of a video signal and a backlight light source to improve image quality of a display video and a television receiving device.

### BACKGROUND OF THE INVENTION

In recent years, as to a display technology of a television receiver, a technology of HDR (high dynamic range imaging) for displaying by reproducing what exists in nature faithfully has been studied actively. One of the objects of the HDR is that, for example, a luminescent color part such as fireworks and neon in a screen is reproduced faithfully to provide feeling of brightness.

In this case, a luminescent color and an object color are detected by a light emission detection function to be separated, and by signal processing and light emission luminance control of a backlight, only the luminescent color on the screen is able to be made brighter. Here, in a video that changes variously, a part that emits light relatively brightly is detected from a distribution of luminance of the video, and the light emitting part is stretched consciously, so that it is possible to obtain effect of improving image quality by emphasizing the part that emits light on the screen more.

As a conventional technology, for example, Patent Literature 1 discloses a display device aiming to realize appropriate screen display luminance corresponding to a content of a video and reduce power consumption sufficiently. This liquid crystal display device changes luminance conversion characteristics that prescribe light emission luminance of a backlight light source with respect to a feature quantity of an input video signal (for example, APL) according to an image quality mode set in the device. At this time, the luminance conversion characteristics are able to be further changed according to brightness detected by a brightness sensor.

### PRIOR ART DOCUMENT

### Patent Documents

[Patent Literature 1] Japanese Laid-Open Patent Publication No. 2007-140436

### SUMMARY OF THE INVENTION

### Problem to be Solved by the Invention

As described above, in the technology of the HDR, by detecting a light emitting part which is brilliant brightly in a screen and stretching display luminance of the light emitting part, contrast feeling is improved for human eyes and feeling of brightness is increased, thus making it possible to provide a high-definition display video.

Here, some video display devices are able to set various image quality modes. By setting an image quality mode arbitrarily, image quality adjustment processing that is set in advance is performed and video display is performed. Examples of such an image quality mode include a dynamic mode focusing on brightness feeling, a standard mode targeted for standard image quality, a movie mode for viewing a movie content, and a PC (Personal Computer) mode for viewing a content output from a PC, for example.

A way in which a display screen displayed in the video display device is seen changes according to setting of an image quality mode. At this time, when the HDR is operated under a constant condition regardless of a state of the image quality mode, there is a case where some videos appear dazzling to cause incongruity, and so-called black float becomes prominent to degrade quality.

For example, when the movie mode is set in the video display device, for example, a user tries to view a movie content having many screens that are relatively dark for a long period of time carefully. In such a case, when screen luminance is increased uniformly by signal processing with the HDR and luminance stretching of the backlight, there is a case where feeling of dazzling is increased in spite of trying to view carefully, thus causing fatigue. Moreover, in a movie content having many dark screens, so-called black float becomes prominent by luminance stretching of the HDR, thus degrading appearance quality in some cases. In image quality modes that are different in this manner, since image quality is required corresponding to each of the image quality modes, when luminance stretching is performed uniformly by the HDR, depending on a video content or an environment, there is a case where incongruity is caused for a video due to feeling of dazzling or the like or a case where video quality is degraded due to black float or the like.

The video display device of the Patent Literature 1 changes luminance conversion characteristics that prescribe light emission luminance of the backlight light source with respect to the feature quantity of the input video signal according to the image quality mode that is set, but is not for detecting a light emitting part to stretch the luminance at that time, and does not disclose such ideas that a light emitting part in a screen is particularly emphasized to be made brighter, and, at this time, degree of luminance stretching is controlled according to the image quality mode to thereby suppress feeling of dazzling and prevent degrade of video quality due to black float.

The present invention has been made in view of circumstances as described above, and aims to provide a video display device that detects apart of a video signal that emits light, and stretches and emphasizes display luminance of the light emitting part for displaying, to thereby perform display with feeling of brightness much increased and with high contrast, and at this time, controls luminance stretching according to an image quality mode that is set in the video display device to thereby represent a high-definition video without incongruity at all times, and a television receiving device.

### Means for Solving the Problem

To solve the above problems, a first technical means of the present invention is a video display device comprising: a display portion for displaying an input video signal; a light source for illuminating the display portion; and a control portion for controlling the display portion and the light source, wherein the control portion stretches and increases luminance of the light source based on an index associated with brightness calculated from the input video signal based on a predetermined condition as well as generates a histogram that the number of pixels are integrated with respect to a predetermined feature quantity of the input video signal to detect an upper area in a predetermined range of the histogram as a light emitting part, and enhances display luminance of the light emitting part by reducing luminance of a video signal of a non-light emitting part excluding the light emitting part, the video display device has an image quality mode setting portion that sets an image quality mode of the video display device, and the control portion switches control curves that define a relation between the index associated with the brightness and a luminance stretch quantity for stretching the luminance of the light source, in accordance with the image quality mode set to the image quality mode setting portion.

A second technical means is the video display device of the first technical means, wherein the control portion divides an image by the input video signal into a plurality of areas, and changes a corresponding lighting rate of the light source for each of the areas based on a tone value of a video signal of the divided area, the control curve is a control curve that defines a relation between an average lighting rate obtained by averaging the lighting rates corresponding to all areas and the luminance stretch quantity shown by possible maximum luminance on a screen of the display portion, and the control portion uses the average lighting rate as the index associated with the brightness to stretch the luminance of the light source based on the maximum luminance defined in accordance with the average lighting rate.

A third technical means is the video display device of the second technical means, wherein the control curve has a maximum value that the stretch quantity of the light source becomes the largest at a specific average lighting rate, and a value of the maximum value changes in accordance with the image quality mode.

A fourth technical means is the video display device of the second or the third technical means, wherein the control curve has a maximum value that the stretch quantity of the light source becomes the largest at a specific average lighting rate, and the maximum value changes in a direction where the average lighting rate increases or decreases in accordance with the image quality mode.

A fifth technical means is the video display device of the first technical means, wherein the control curve is a control curve that defines a relation between a score obtained by counting the number of pixels by weighting brightness of each pixel and the luminance stretch quantity with respect to a video in a predetermined range including an area of the detected light emitting part, and the control portion uses the score as the index associated with the brightness to stretch the luminance of the light source based on the score that is calculated from the input video signal.

A sixth technical means is the video display device of the fifth technical means, wherein the control curve has a maximum value that the stretch quantity of the light source becomes the largest in a specific area of the score, and a value of the maximum value changes in accordance with the image quality mode.

A seventh technical means is the video display device of the fifth or the sixth technical means, wherein the control curve has a maximum value that the stretch quantity of the light source becomes the largest in a specific area including a highest value of the score, and a value of the score at a point where the luminance stretch quantity starts to be reduced from a level of the maximum value as the score decreases changes in accordance with the image quality mode.

An eighth technical means is the video display device of any one of the second to the seventh technical means, wherein the control portion performs video processing for converting and outputting an input tone of the input video signal, input/output characteristics that define a relation between the input tone and an output tone have a first threshold that is defined in an area of a non-light emitting part having a lower tone than a boundary of the light emitting part and the non-light emitting part, and a second threshold that defines the boundary of the light emitting part and the non-light emitting part, and the control portion predefines a relation between a gain applied to the video signal and the luminance stretch quantity, and determines a gain by which the output tone is reduced with respect to the input tone of the input video signal in accordance with the luminance stretch quantity and applies the determined gain to an area having a lower tone than the first threshold to perform the video processing, and in accordance with the image quality mode set to the image quality mode setting portion, changes the first threshold and/or the second threshold in accordance with the image quality mode set to the image quality mode setting portion, in the video processing.

A ninth technical means is the video display device of any one of the first to the eighth technical means, wherein when an average value is A and a standard deviation is σ in the histogram, the control portion regards, as the light emitting part, a pixel that is not less than: thresh=A+Nσ (N is a constant).

A tenth technical means is the video display device of the eighth technical means, wherein the control portion reduces an increment of display luminance of the display portion by stretching of the luminance of the light source through the video processing in a predetermined area having the low feature quantity.

An eleventh technical means is a television receiving device including the video display device of any one of the first to the tenth technical means.

### Effect of the Invention

According to the present invention, it is possible to provide a video display device that detects a part of a video signal that emits light, and stretches and emphasizes display luminance of the light emitting part for displaying, to thereby perform display with feeling of brightness much increased and with high contrast, and at this time, controls luminance stretching according to an image quality mode that is set in the video display device to thereby represent a high-definition video without incongruity at all times, and a television receiving device.

### BRIEF DESCRIPTION OF DRAWINGS

FIG. 1 is a diagram explaining an embodiment of a video display device according to the present invention, which shows a main configuration of the video display device.

FIG. 2 is a diagram explaining control processing of a light emitting area in an area-active-control/luminance-stretching portion.

FIG. 3 is another diagram explaining control processing of a light emitting area in the area-active-control/luminance-stretching portion.

FIG. 4 is a diagram specifically explaining determination processing of an average lighting rate.

FIG. 5 is a diagram explaining exemplary processing of the area-active-control/luminance-stretching portion.

FIG. 6 is a diagram showing an example of a Y histogram generated from a luminance signal Y.

FIG. 7 is a diagram showing an example of tone mapping generated by a mapping portion.

FIG. 8 is a diagram explaining Max luminance output by the area-active-control/luminance-stretching portion.

FIG. 9 is a diagram explaining exemplary control of Max luminance that is changed according to an image quality mode.

FIG. 10 is a diagram explaining another exemplary control of Max luminance that is changed according to an image quality mode.

FIG. 11 is a diagram explaining still another exemplary control of Max luminance that is changed according to an image quality mode.

FIG. 12 is a diagram explaining still another exemplary control of Max luminance that is changed according to an image quality mode.

FIG. 13 is a diagram explaining a first threshold and a second threshold that are changed according to an image quality mode.

FIG. 14 is a diagram explaining an example of tone mapping that is changed according to an image quality mode.

FIG. 15 is a diagram explaining another example of tone mapping that is changed according to an image quality mode.

FIG. 16 is a diagram explaining still another example of tone mapping that is changed according to an image quality mode.

FIG. 17 is a diagram explaining still another example of tone mapping that is changed according to an image quality mode.

FIG. 18 is a diagram showing a state where screen luminance is enhanced by processing of the area-active-control/luminance-stretching portion 14.

FIG. 19 is a diagram explaining a second embodiment of the video display device according to the present invention.

FIG. 20 shows an example of a Y histogram generated from a luminance signal Y of an input video signal.

FIG. 21 is a diagram showing exemplary calculation of a luminance stretch quantity according to a pixel not less than a third threshold.

FIG. 22 is a diagram explaining exemplary setting of a control curve of a luminance stretch quantity.

FIG. 23 is a diagram explaining another exemplary setting of a control curve of a luminance stretch quantity that is changed according to an image quality mode.

FIG. 24 is a diagram explaining still another exemplary setting of a control curve of a luminance stretch quantity that is changed according to an image quality mode.

FIG. 25 is a diagram explaining still another exemplary setting of a control curve of a luminance stretch quantity that is changed according to an image quality mode.

FIG. 26 is a diagram explaining an example of tone mapping that is changed according to an image quality mode.

FIG. 27 is a diagram explaining another example of tone mapping that is changed according to an image quality mode.

FIG. 28 is a diagram explaining still another example of tone mapping that is changed according to an image quality mode.

FIG. 29 is a diagram explaining still another example of tone mapping that is changed according to an image quality mode.

FIG. 30 is a diagram explaining still another embodiment of the video display device according to the present invention.

FIG. 31 is a diagram explaining a method for calculating a CMI from a broadcast video signal to be displayed on the video display device.

FIG. 32 is a diagram explaining a maximum tone value of RGB used as a feature quantity.

### PREFERRED EMBODIMENT OF THE INVENTION

### Embodiment 1

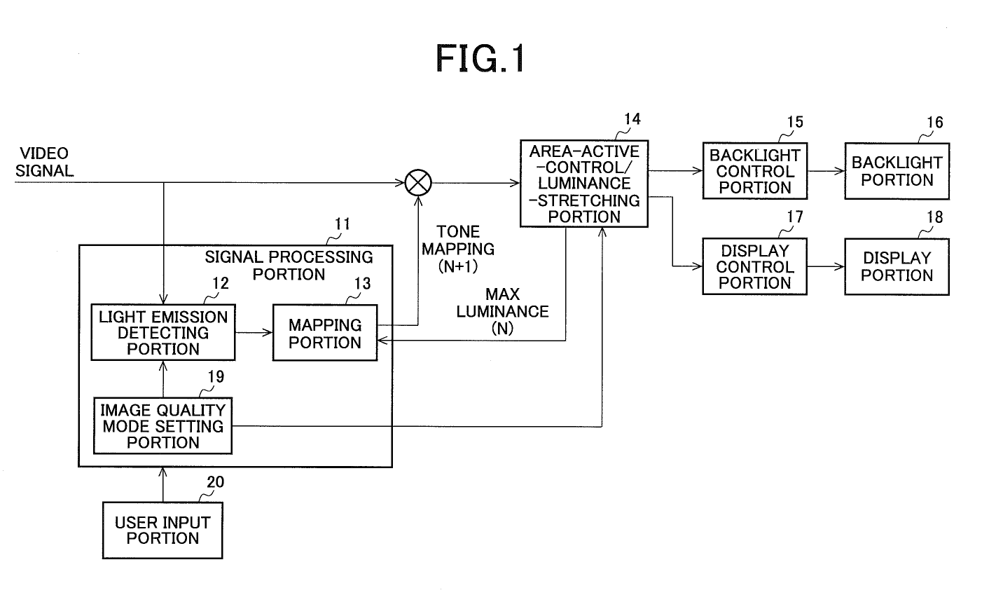

FIG. 1 is a diagram explaining an embodiment of a video display device according to the present invention, which shows a main configuration of the video display device. The video display device has a configuration to perform image processing for an input video signal to display a video, and is applicable to a television receiving device and the like.

A video signal separated from a broadcast signal and a video signal input from external equipment are input to a signal processing portion 11 and an area-active-control/luminance-stretching portion 14. At this time, the video signal to the area-active-control/luminance-stretching portion 14 is applied with tone mapping generated by a mapping portion 13 of the signal processing portion 11, and then input to the area-active-control/luminance-stretching portion 14.

A light emission detecting portion 12 of the signal processing portion 11 generates a histogram for each frame based on a feature quantity of an input video signal and detects a part that emits light. The part that emits light is obtained by an average value and a standard deviation of the histogram, and is detected as a relative value for each histogram.

An image quality mode setting portion 19 sets an image quality mode of the video display device, and outputs setting information thereof to the light emission detecting portion 12 and the area-active-control/luminance-stretching portion 14. Examples of the image quality mode include a dynamic mode, a standard mode, a movie mode and a PC mode. Characteristics of each image quality mode and exemplary control at this time will be described below.

For setting of the image quality mode in the image quality mode setting portion 19, it is possible to perform setting by a user operation by a user input portion 20. The user input portion 20 allows predetermined user input by a user, and is able to be configured by, for example, a remote controlling device, or a key, a button group and the like, which are not shown, provided in a main body of the video display device.

The mapping portion 13 generates tone mapping by using information of the light emitting part detected by the light emission detecting portion 12 and Max luminance output from the area-active-control/luminance-stretching portion 14 to apply to the input video signal. The Max luminance shows maximum luminance that is desired to be displayed on a screen and corresponds to a luminance stretch quantity of a backlight.

In accordance with the video signal that is input, the area-active-control/luminance-stretching portion 14 divides an image by the video signal into predetermined areas, and extracts a predetermined statistical value, such as a maximum tone value, of the video signal for each divided area. Then, a lighting rate of a backlight portion 16 is calculated based on the maximum tone value or the like. The lighting rate is defined for each area of the backlight portion 16 corresponding to a divided area of a video. In addition, the backlight portion 16 is configured by a plurality of LEDs and is able to control luminance for each area.

The lighting rate in each area of the backlight portion 16 is determined based on a predefined operation expression, in which operation is performed basically in such a way as to keep luminance of an LED without reducing in a bright high-tone area with a maximum tone value while reducing luminance of an LED in a dark low-tone area.

Then, the area-active-control/luminance-stretching portion 14 calculates an average lighting rate of the entire backlight portion 16 from a lighting rate of each area, and according to the average lighting rate, calculates a luminance stretch quantity of the backlight portion 16 by a predetermined operation expression. Thereby, a possible maximum luminance value (Max luminance) of an area in a screen is obtained. Here, Max luminance is determined based on setting information of the image quality mode by the image quality mode setting portion 19, and output to the mapping portion 13 of the signal processing portion 11.

In the area-active-control/luminance-stretching portion 14, then, Max luminance determined according to the image quality mode set to the image quality mode setting portion 19 is returned to the signal processing portion 11 to reduce luminance corresponding to a quantity of luminance stretching of the backlight portion 16.

At this time, the luminance stretching is given to the entire backlight portion 16, and reduction of luminance by video signal processing is performed for a part that is regarded as not emitting light, excluding a light emitting part. Thereby, screen luminance of only the part that emits light is increased, thus making it possible to perform video representation with high contrast and improve image quality.

The area-active-control/luminance-stretching portion 14 outputs control data for controlling the backlight portion 16 to a backlight control portion 15, and the backlight control portion 15 controls light emission luminance of the LED of the backlight portion 16 for each divided area based on the data. Luminance of the LED of the backlight portion 16 is subjected to PWM (Pulse Width Modulation) control, and is also able to be controlled to have a desired value by current control or a combination thereof.

Further, the area-active-control/luminance-stretching portion 14 outputs control data for controlling a display portion 18 to a display control portion 17, and the display control portion 17 controls display of the display portion 18 based on the data. A liquid crystal panel that displays an image with illumination by the LED of the backlight portion 16 is used for the display portion 18.

Note that, in the present embodiment, a control portion of the present invention is for controlling the backlight portion 16 and the display portion 18, and corresponds to the signal processing portion 11, the area-active-control/luminance-stretching portion 14, the backlight control portion 15 and the display control portion 17.

When the above-described display device is configured as a television receiving device, the television receiving device has means for selecting a broadcast signal received by an antenna for demodulating and decoding to generate a video signal for playing, and applies predetermined image processing as appropriate to the video signal for playing for inputting as the input video signal of FIG. 1. This makes it possible to cause the display portion 18 to display the received broadcast signal. The present invention is able to be configured as a video display device, and a television receiving device provided with the video display device.

More specific description will be given below for exemplary processing of each portion of the present embodiment having the above-described configuration.

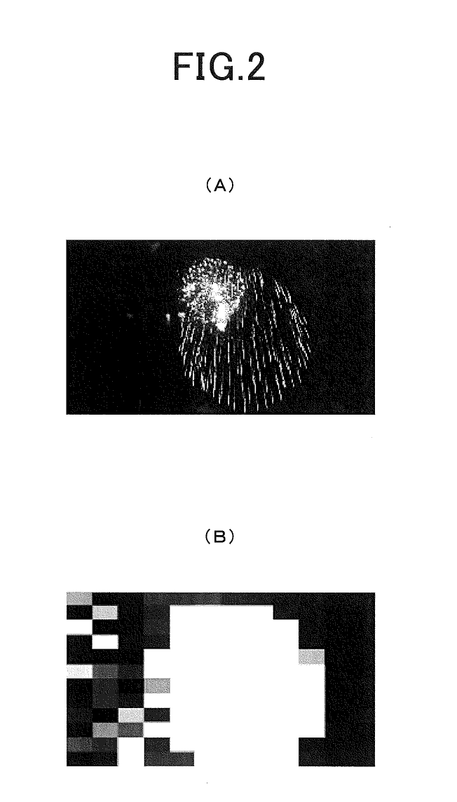

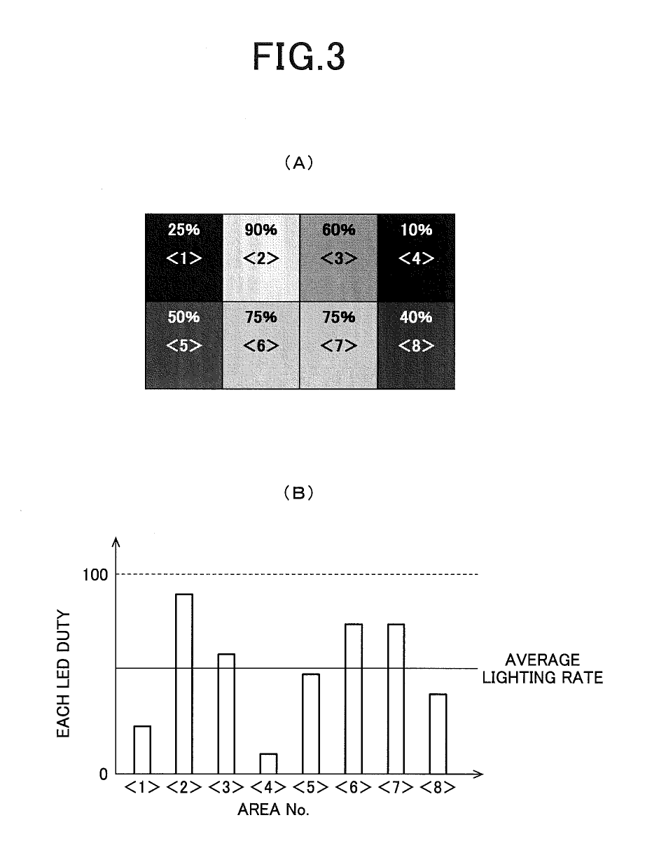

The area-active-control/luminance-stretching portion 14 divides a video into a predetermined plurality of areas, and controls light emission luminance of the LED corresponding to the divided areas for each area. FIG. 2 to FIG. 3 are diagrams explaining control processing of a light emitting area in the area-active-control/luminance-stretching portion 14. The area active control applied to the present embodiment is for dividing a video into a predetermined plurality of areas and controlling light emission luminance of the LED corresponding to the divided areas for each area.

Here, the area-active-control/luminance-stretching portion 14 divides a video of one frame into a predefined plurality of areas based on an input video signal, and extracts a maximum tone value of the video signal for each divided area. For example, a video as shown in FIG. 2(A) is divided into a predefined plurality of areas. Here, the maximum tone value of the video signal for each area is extracted. In another example, not the maximum tone value but other statistical values such as an average tone value of the video signal may be used. Description will be given below with an example in which a maximum tone value is extracted.

The area-active-control/luminance stretching portion 14 determines a lighting rate of the LED for each area according to the extracted maximum tone value. A situation in the lighting rate of the LED of each area at this time is shown in FIG. 2(B). Bright display is performed with the lighting rate of the LED increased for a bright part where a tone of the video signal is high. Processing at this time will be described more specifically.

An example of a situation when a maximum tone value of each divided area of one frame is extracted is shown in FIG. 3. In FIG. 3, for simplifying description, it is set that a screen of one frame is divided into eight areas (areas <1> to <8>). Lighting rates of the respective areas (areas <1> to <8>) are shown in FIG. 3(A), and lighting rates of the respective areas and an average lighting rate of the entire screen are shown in FIG. 3(B). Here, from a maximum tone value in each area, a lighting rate of the LED of the backlight in the area is calculated. The lighting rate is able to be indicated by, for example, a drive duty of the LED. In this case, the Max lighting rate is 100%.

When determining the lighting rate of the LED of each area, the lighting rate is decreased to reduce the luminance of the backlight for a dark area where the maximum tone value is low. As an example, when being represented by 8-bit data with a tone value of a video of 0 to 255, if the maximum tone value is 128, the backlight is reduced to (1/(255/128))^{2.2}=0.217 time (21.7%).

In the example of FIG. 3, the lighting rate of the backlight is determined in a range of 10 to 90% for each area. This method for calculating a lighting rate shows an example thereof, and the light rate in each area is calculated in accordance with a predefined operation expression basically so as not to reduce backlight luminance in a bright high-tone area but to reduce luminance of the backlight in a dark low-tone area.

Then, lighting rates of the backlight for each area calculated from the maximum tone value of the video signal are averaged to calculate the average lighting rate of the backlight in one frame. In this example, the average lighting rate becomes a level of the average lighting rate shown in FIG. 3(B). The average lighting rate is an example of an index associated with brightness according to the present invention.

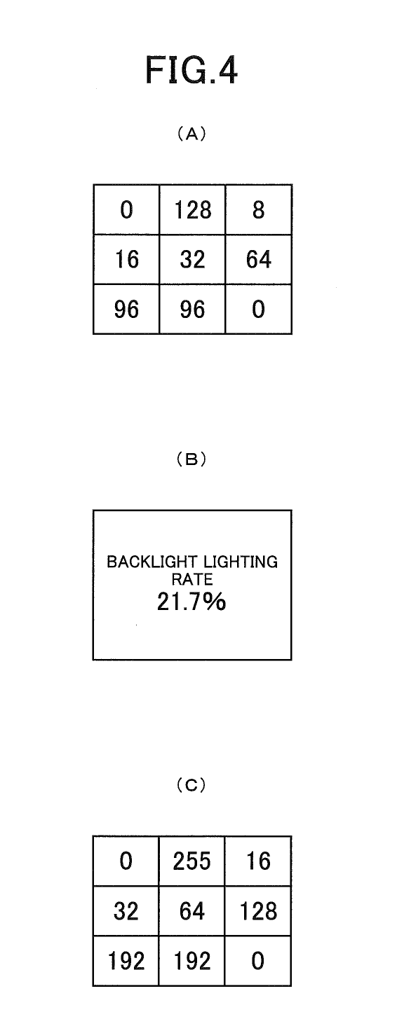

FIG. 4 is a diagram explaining determination processing of the average lighting rate more specifically. As described above, when determining the lighting rate of the LED of each area, the lighting rate is decreased to reduce the luminance of the backlight for a dark area where the maximum tone value is low. Here, the actual lighting rate in each area is determined so that tone which is desired to be displayed is displayed correctly and the LED duty is reduced as much as possible. While it is desired to reduce the LED duty as much as possible in each area, it is necessary to perform display correctly without collapsing tone which is desired to be displayed, so that the LED duty by which the maximum tone in the area is able to be displayed and the LED duty is reduced as much as possible (tentative lighting rate) is set and tone of the display portion 18 (here, LCD panel) is set based on it.

As an example, description will be given for a case of being represented by 8-bit data with a tone value of a video of 0 to 255 and a case where tone values of a plurality of pixels in one area of FIG. 3(A) are shown in FIG. 4(A). Here, it is set that nine pixels correspond to one area. In a pixel group shown in FIG. 4(A), the maximum tone value is 128, and in this case, as shown in FIG. 4(B), a lighting rate of the backlight in the area is reduced to (1/(255/128))^{2.2}=0.217 time (21.7%).

Further, as an example, the area-active-control/luminance stretching portion 14 determines the lighting rate in this manner and calculates a tone value for each pixel in the display portion 18 by considering the lighting rate for the area in which the pixel is included. For example, when the tone value that is desired to be displayed is 96, 96/(128/255)=192, so that the pixel may be represented using the tone value of 192. In the same manner, a result of calculating tone values when being displayed for each pixel of FIG. 4(A) is shown in FIG. 4(C).

The actual luminance of the backlight portion 16 is further stretched and intensified based on a value of Max luminance determined according to the average lighting rate. Reference luminance as an origin thereof is, for example, such luminance that screen luminance at a time of the maximum tone value is 550 (cd/m²). The reference luminance is not limited to this example and is able to be defined as appropriate.

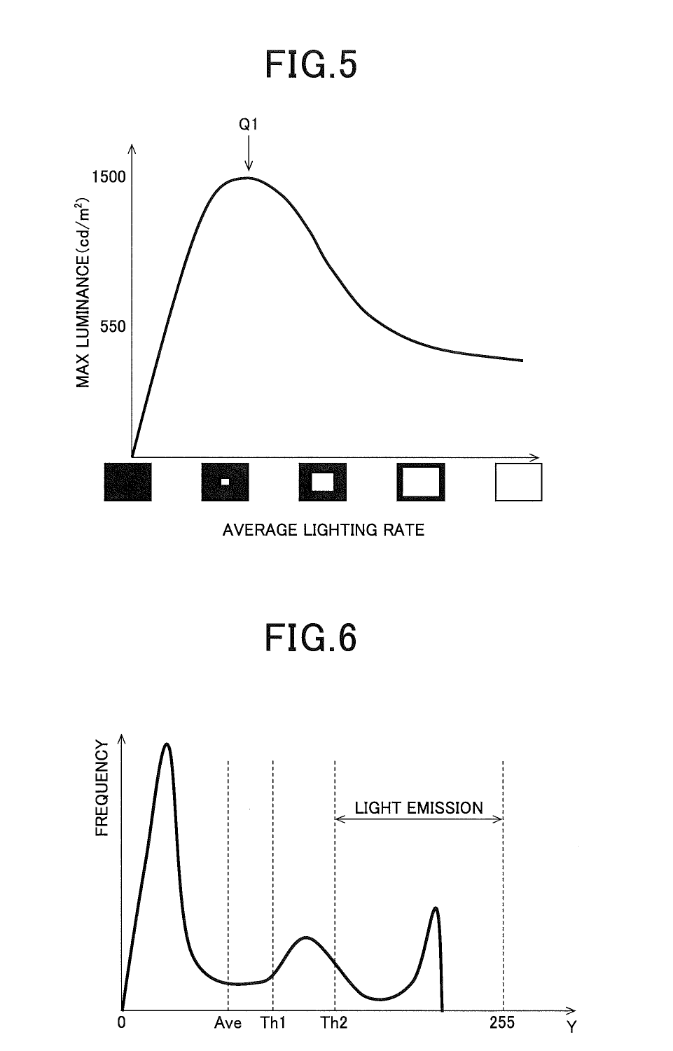

FIG. 5 is a diagram explaining exemplary processing of the area-active-control/luminance-stretching portion 14. As described above, the area-active-control/luminance-stretching portion 14 calculates the average lighting rate of the entire screen from the lighting rates determined according to the maximum tone value in each area. When an area in which the lighting rate is high is increased, the average lighting rate of the entire screen becomes higher. Then, a possible maximum value of luminance (Max luminance) in a relation like FIG. 5 is determined. A horizontal axis indicates a lighting rate of the backlight (window size) and a vertical axis indicates screen luminance in Max luminance (cd/m²). The average lighting rate is able to be expressed as a ratio of a lit area (window area) with the lighting rate of 100% to an unlit area with the lighting rate of 0%. The lighting rate is 0 in a state of having no lit area, and the lighting rate increases as a window of a lit area becomes larger and the lighting rate reaches 100% when completely lit.

In FIG. 5, it is set that Max luminance when the back light is completely lit (average lighting rate of 100%) is, for example, 550 (cd/m²). Then, as the average lighting rate decreases, Max luminance is increased. At this time, a pixel having a tone value of 255th tone (in the case of 8-bit representation) has the highest screen luminance in the screen, which is possible maximum screen luminance (Max luminance). Accordingly, it is found that, even with the same average lighting rate, the screen luminance is not upped by Max luminance depending on the tone value of the pixel.

When the average lighting rate is Q1, Max luminance has the largest value, and the maximum screen luminance at this time is 1500 (cd/m²). That is, the possible maximum screen luminance at Q1 is to be stretched to 1500 (cd/m²) compared to 550 (cd/m²) when completely lit. Q1 is set at a position where the average lighting rate is relatively low. That is, in the case of such a screen that is a wholly dark screen having low average lighting rate and that has a high-tone peak partially, the luminance of the backlight is stretched to be 1500 (cd/m²) at a maximum. Further, as a reason why degree of stretching of the luminance of the backlight is small as the average lighting rate becomes higher, because it feels dazzling instead when performing excessively for the luminance of the backlight in an originally bright screen, it is required to suppress degree of stretching.

While Max luminance is from the maximum average lighting rate of Q1 to the average lighting rate of 0 (perfectly black), the value of Max luminance is gradually reduced. In a predetermined area where the average lighting rate is the lowest, the screen luminance is further reduced than 550 (cd/m²) when completely lit. That is, by using a case of being completely lit as a reference, the screen luminance is to be stretched to the minus side. A range where the average lighting rate is low corresponds to a video on a dark screen, and rather than the luminance of the backlight is stretched to up the screen luminance, the luminance of the backlight is suppressed to the contrary to improve contrast feeling and black float is suppressed to keep display quality.

The area-active-control/luminance-stretching portion 14 stretches the luminance of the backlight in accordance with a curve of FIG. 5, and outputs a control signal thereof to the backlight control portion 15. Here, the average lighting rate changes according to the maximum tone value detected for each divided area of the video as described above, and a state of luminance stretching changes according to the average lighting rate.

A video signal input to the area-active-control/luminance-stretching portion 14 is applied with tone mapping generated by signal processing of the signal processing portion 11 described below to be input having a low-tone area with gain decreased. Thereby, the luminance is reduced by video signal processing by a quantity of the stretched luminance of the backlight in a non-light emitting area with low tone, resulting that screen luminance is enhanced only in an area that emits light, thus increasing feeling of brightness.

The area-active-control/luminance-stretching portion 14 outputs the value of Max luminance determined from the average lighting rate of the backlight and the setting information of the image quality mode from the image quality mode setting portion 19 in accordance with the curve of FIG. 5 to the mapping portion 13 of the signal processing portion 11. The mapping portion 13 performs tone mapping using Max luminance output from the area-active-control/luminance-stretching portion 14.

The signal processing portion 11 will be described. The light emission detecting portion 12 of the signal processing portion 11 detects a part that emits light from a video signal. FIG. 6 shows an example of a Y histogram generated from a luminance signal Y. The light emission detecting portion 12 integrates the number of pixels for each luminance tone to generate a Y histogram for each frame of an input video signal. A horizontal axis indicates a tone value of luminance Y, and a vertical axis indicates the number of pixels integrated for each tone value (frequency). The luminance Y is one of feature quantities of a video for which a histogram is generated, and another example of feature quantities will be described below. Here, it is set to detect a light emitting part as to the luminance Y.

When the Y histogram is generated, an average value (Ave) and a standard deviation (σ) are calculated from the Y histogram, which are used for calculating two thresholds Th.

A second threshold Th2 is for defining a light emitting boundary, and in the Y histogram, processing is performed for pixels not less than the threshold Th2 which are regarded as a light emitting part.

The second threshold Th2 is provided by:

Th2=Ave+Nσ expression (1)

N is a predetermined constant.

In addition, a first threshold Th1 is set so as to suppress incongruity in tones of an area smaller than Th2 and the like, and provided by:

Th1=Ave+Mσ expression (2)

M is a predetermined constant, and M<N. Further, a value of M changes according to the image quality mode set to the image quality mode setting portion 19.

The values of the first and second thresholds Th1 and Th2 detected by the light emission detecting portion 12 are output to the mapping portion 13 and used to generate tone mapping.

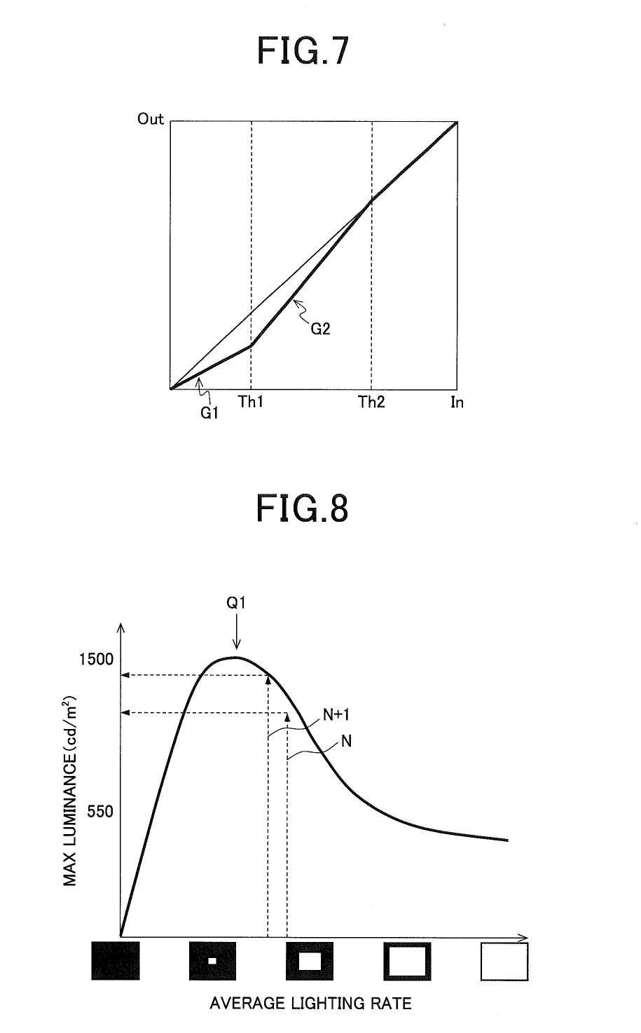

FIG. 7 is a diagram showing an example of tone mapping generated by the mapping portion 13. A horizontal axis is an input tone of a luminance value of a video, and a vertical axis is an output tone. A pixel not less than the second threshold Th2 detected by the light emission detecting portion 12 is a part that emits light in the video, and a compression gain is applied excluding the part that emits light for decreasing a gain. At this time, when a constant compression gain is uniformly applied to an area smaller than Th2 serving as a light emitting boundary to suppress the output tone, there is incongruity arising in tones. Therefore, the first threshold Th1 is set and detected at the light emission detecting portion 12, a first gain G1 is set to an area smaller than Th1, and a second gain G2 is set so as to linearly connect between Th1 and Th2 to perform tone mapping.

Description will be given for a method for setting a gain.

A value of Max luminance is input from the area-active-control/luminance-stretching portion 14 to the mapping portion 13. As described above, Max luminance shows maximum luminance that is determined by an average lighting rate of the backlight and setting information of the image quality mode by the image quality mode setting portion 19, and is input, for example, as a value of backlight duty.

The first gain G1 is applied to an area smaller than the first threshold Th1, and is set by:

G1=(Ls/Lm)^{1/γ} expression (3)

Ls is reference luminance (reference luminance when backlight luminance is not stretched; as an example, luminance when maximum screen luminance becomes 550 cd/m²), and Lm is Max luminance output from the area-active-control/luminance-stretching portion 14. Accordingly, the first gain G1 that is applied to the area smaller than the first threshold Th1 lowers an output tone of a video signal so as to reduce an increment of screen luminance by luminance stretching of the backlight.

In tone mapping for the second threshold Th2 or more, it is set as f(x)=x. That is, it is set as an input tone=an output tone, and processing for reducing the output tone is not performed. It is set so that the output tone of the first threshold Th1 reduced by the first gain G1 and the output tone of the first threshold Th1 are connected with a straight line from the first threshold Th1 to the second threshold Th2.

That is, the second gain G2 is determined by:

G2=(Th2−G1·Th1)/(Th2−Th1) expression (4)

By the above-described processing, tone mapping as shown in FIG. 7 is obtained. At this time, for a connecting part of Th1 and Th2, a predetermined range (for example, connecting part±Δ (Δ is a predetermined value)) may be subjected to smoothing by a quadratic function.

The tone mapping generated by the mapping portion 13 is applied to an input video signal, and the video signal in which output of a low-tone part is suppressed based on a luminance stretch quantity of the backlight is input to the area-active-control/luminance-stretching portion 14.

FIG. 8 is a diagram explaining Max luminance output by the area-active-control/luminance-stretching portion 14.

The area-active-control/luminance-stretching portion 14 inputs the video signal to which tone mapping generated by the mapping portion 13 is applied, and performs area active control based on the video signal to determine Max luminance based on an average lighting rate. At this time, though a control curve of Max luminance changes according to setting information of the image quality mode from the image quality mode setting portion 19, the image quality mode is not considered here for description.

It is set that pa frame that is determined based on the above-described average lighting rate is an N frame. A value of Max luminance of the N frame is output to the mapping portion 13 of the signal processing portion 11. At the mapping portion 13, Max luminance of the N frame that is input is used to generate tone mapping shown in FIG. 7, which is applied to a video signal of an N+1 frame.

In this manner, Max luminance based on an area-active average lighting rate is given feedback to be used for tone mapping for a next frame. The mapping portion 13 applies again for reducing video output for the area that is smaller than the first threshold Th1 (first gain G1) based on Max luminance determined in the N frame. The second gain G2 for linearly connecting between Th1 and Th2 is applied to an area between Th1 and Th2 to reduce video output between Th1 and Th2.

Because the gain for reducing video output is applied in the N frame, in an area having a high lighting rate in which an average lighting rate is not less than Q1, the N+1 frame has a trend that a maximum tone value for each area is reduced so that a lighting rate is reduced, and thereby, the N+1 frame has a trend that Max luminance increases. This causes a trend that a luminance stretch quantity of the backlight is further increased to increase feeling of brightness on a screen. However, these trends are not found in an area having a lighting rate lower than Q1, and an opposite trend is found.

Next, description will be given for processing according to the image quality mode. In the embodiment according to the present invention, the control curve of Max luminance according to an average lighting rate as shown in FIG. 5 above is changed according to an image quality mode set to the image quality mode setting portion 19.

### (Exemplary Control of Luminance of Backlight Based on Image Quality Mode)

As described above, the area-active-control/luminance-stretching portion 14 inputs the video signal to which tone mapping generated by the mapping portion 13 is applied, and performs area active control based on the video signal to determine Max luminance based on an average lighting rate. At this time, in the area-active-control/luminance-stretching portion 14, a control curve of Max luminance is differentiated according to the image quality mode set to the image quality mode setting portion 19. Moreover, at the same time, in the mapping portion 13, according to the image quality mode set to the image quality mode setting portion 19, the first threshold Th1 and the second threshold Th2 are shifted to a direction of a feature quantity of luminance or the like, so that optimal video display according to the image quality mode is performed.

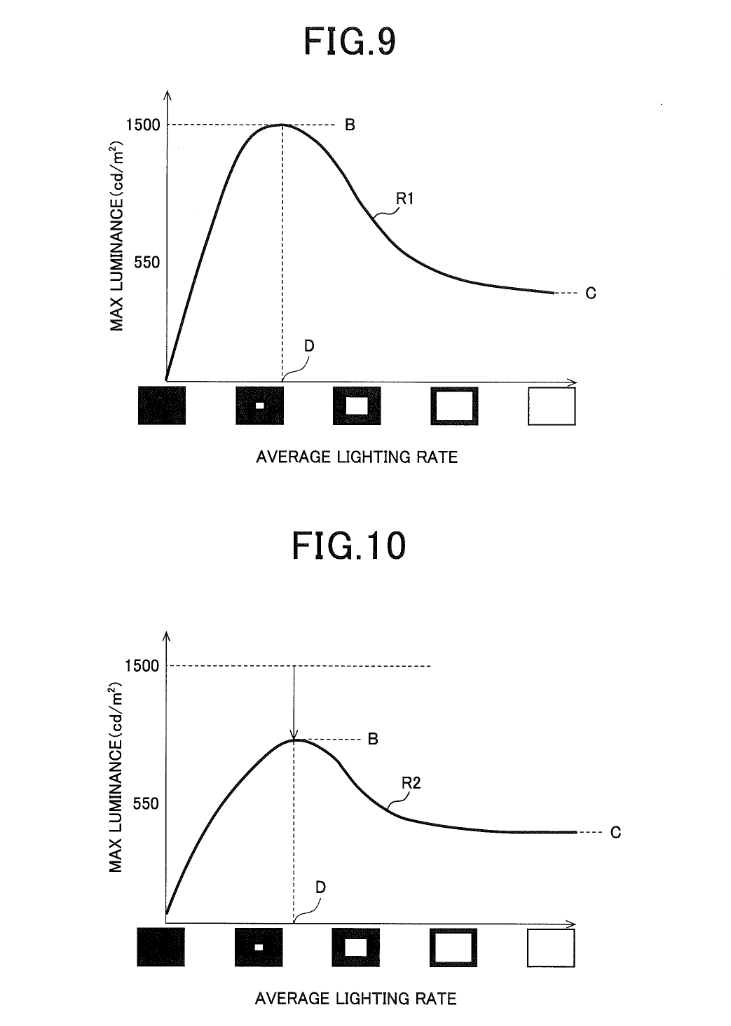

FIG. 9 is a diagram explaining exemplary control of Max luminance that is changed according to an image quality mode, which shows exemplary control of Max luminance when the image quality mode is a dynamic mode.

As described above, the area-active-control/luminance-stretching portion 14 calculates an average lighting rate of the entire screen from lighting rates determined according to a maximum tone value of each area and the like. When an area having a high lighting rate increases, the average lighting rate of the entire screen becomes high. Then, a possible maximum value of luminance (Max luminance) is determined with a relation like in FIG. 9.

At this time, according to the image quality mode set to the image quality mode setting portion 19, a control curve that defines a relation between Max luminance and the average lighting rate in FIG. 9 is changed. FIG. 9 shows an example of the control curve at a time of the dynamic mode.

The dynamic mode is a mode for enabling to view, for example, a sports program or the like as one full of impact with a clear and vivid video. The dynamic mode is able to be used as a demonstration mode (also referred to as shop front mode) for appealing a feature of the device at a shop front of a dealer, for example. The dynamic mode is typically executed with best image quality and brightness prepared for the video display device.

As shown in FIG. 9, in the dynamic mode, a maximum value of Max luminance is set high as well as a level of the average lighting rate having a maximum value of Max luminance is set relatively high. For example, when a level of the highest Max luminance in an entire range of the average lighting rate is B, a Max luminance level when the average lighting rate is 100% is C, and the average lighting rate having the highest Max luminance is D, B is set to about 1500 cd/m² and C is set to about 550 cd/m² in a control curve R1 of the dynamic mode. A position of D is set to a position of about 30% where the average lighting rate is relatively high.

Moreover, Max luminance at a minimum lighting rate (lighting rate of 0%) is 0 (cd/m²), and the backlight is completely unlit at this time. That is, with 550 cd/m² at the level C as a reference, the backlight is to be stretched to the minus side in a predetermined area of a low lighting rate. In the dynamic mode, B is set to have luminance difference which is about three times of C, and a ratio of B and C is set to be highest in all image quality modes.

In the control curve R1, by performing luminance stretching greatly with the maximum value B of Max luminance as 1500 cd/m², a bright and brilliant video is provided. Further, by setting Max luminance high to some extent even for an area of a dark video having a low average lighting rate, a video focusing on brightness is provided.

FIG. 10 is a diagram explaining another exemplary control of Max luminance that is changed according to an image quality mode, which shows exemplary control of Max luminance when the image quality mode is a standard mode. The standard mode is a mode showing that setting of image quality or the like has a standard value, and is a mode being conscious of home use mainly. In the standard mode, generally, emphasis is placed on performing video expression naturally, being conscious of power saving to some extent.

In the case of the standard mode of FIG. 10, a control curve R2 that defines a relation between Max luminance and the average lighting rate is different from the control curve R1 of the dynamic mode of FIG. 8. In the control curve R2 of the standard mode, a maximum value of Max luminance is set low compared to the dynamic mode, and, for example, the level B of the highest Max luminance in an entire range of the average lighting rate is set to about 700 cd/m².

The levels of C and D are set to about 550 cd/m² and about 30%, respectively in the same manner as the dynamic mode. Further, Max luminance at a minimum lighting rate (lighting rate of 0%) is 0 (cd/m²) in the same manner as the dynamic mode, and the backlight is completely unlit at this time. In the standard mode, B is set to have luminance difference which is about 1.3 times of C.

In the control curve R2 of the standard mode, by setting the maximum value B of Max luminance at about 700 cd/m², a luminance stretch quantity is suppressed than the dynamic mode, to thereby suppress excessive dazzling on a display screen as well as display an image having sharpness in a standard viewing environment such as at home. Further, in the standard mode, the level of the average lighting rate D having the highest Max luminance is set to be equal to that of the dynamic mode. Thereby, Max luminance is maintained to be high to some extent even for an area of low and dark video, thus providing a video which is not subjected to luminance stretching up to the dynamic mode but has standard brightness.

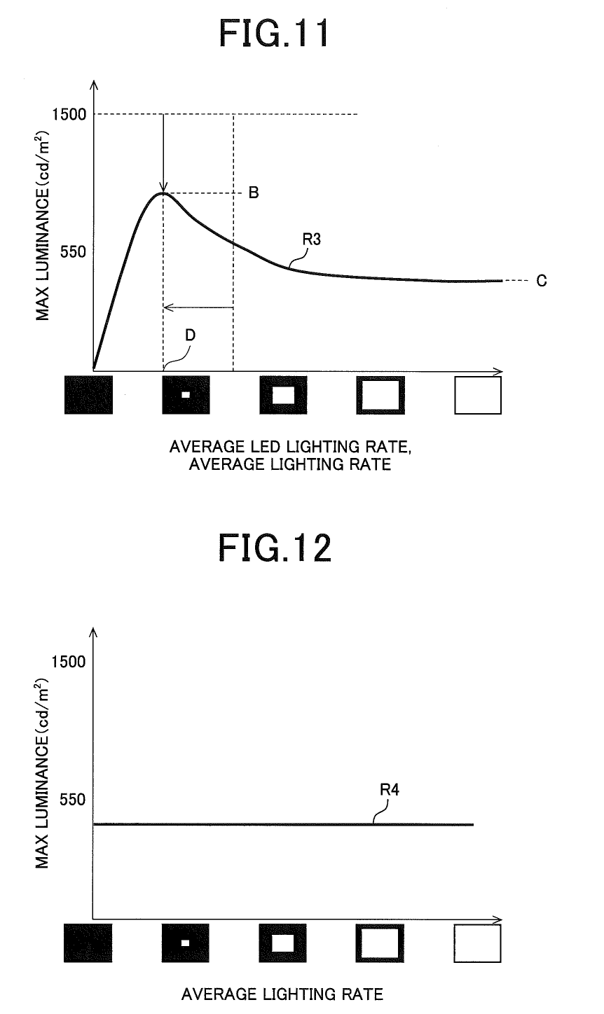

FIG. 11 is a diagram explaining still another exemplary control of Max luminance that is changed according to an image quality mode, which shows exemplary control of Max luminance when the image quality mode is a movie mode. The movie mode is a mode for expressing film feeling by focusing on reproducing a video included in a movie source faithfully.

In the case of the movie mode of FIG. 11, in a control curve R3 that defines a relation between Max luminance and the average lighting rate, a level B of the highest Max luminance in an entire range of the average lighting rate is set to about 700 cd/m² with the same degree as the standard mode. Further, the level of C is set to about 550 cd/m² in the same manner as the dynamic mode and the standard mode. In addition, Max luminance at a minimum lighting rate (lighting rate of 0%) is 0 (cd/m²) in the same manner as the dynamic mode and the standard mode, and the backlight is completely unlit at this time. In the movie mode, B is set to have luminance difference which is about 1.3 times of C.

Here, in the control curve R3 of the movie mode, the level of the average lighting rate D having the highest Max luminance is set to a level lower than the dynamic mode and the standard mode. For example, the average lighting rate D of the movie mode is about 17%. In this manner, by shifting the level of D to a low-average-lighting-rate side compared to the standard mode, it is possible to reproduce a video by preventing feeling dazzling excessively when a movie content or the like is viewed carefully, as well as by focusing on feeling of brightness when there is a peak even though being dark in a divided area, that is, of a bright part having a relatively small area. Further, by setting the level of D low, the highest Max luminance is set when a video is relatively dark, so that even when a video is seen successively for a long period of time like a movie content, it is possible to prevent fatigue due to dazzling from being caused.

FIG. 12 is a diagram explaining still another exemplary control of Max luminance that is changed according to an image quality mode, which shows exemplary control of Max luminance when the image quality mode is a PC mode. The PC mode is a mode for displaying a video output from a PC so as to be easily viewed with an optimum image, and, for example, is for displaying an image having a geometric screen configuration with clear sharpness, which is output from the PC, or the like so as to be easily viewed.

In the case of the PC mode of FIG. 12, in a control curve R4 that defines a relation between Max luminance and the average lighting rate, Max luminance is fixed regardless of the average lighting rate. The level of Max luminance at this time is set as a standard level of about 550 cd/m². That is, in the PC mode, luminance enhancement processing by detection of light emission is substantially turned off. The PC mode focuses on reproduction of faithfulness of a video, and therefore does not perform video processing by detecting a bright part of the video nor perform luminance stretching of the backlight so that an input video signal is to be reproduced faithfully.

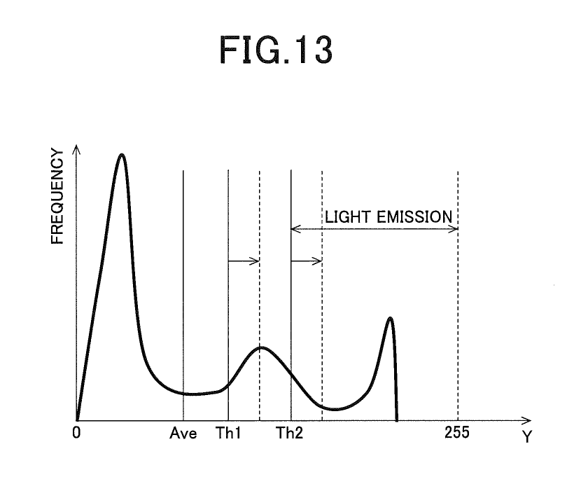

FIG. 13 is a diagram explaining the first threshold and the second threshold that are changed according to an image quality mode. As described above, the light emission detecting portion 12 integrates the number of pixels for each luminance tone to generate a Y histogram for each frame of an input video signal. Then, an average value (Ave) and a standard deviation (σ) are calculated from the Y histogram, and the second threshold Th2 that defines a light emitting boundary and the first threshold Th1 for suppressing incongruity in tones of an area smaller than Th2 and the like (Th1=Ave+Mσ) are set.

At this time, a position of the first threshold Th1 and a position of the second threshold Th2 of FIG. 13 are changed according to the image quality mode set to the image quality mode setting portion 19. Moreover, either the position of the first threshold Th1 or the second threshold Th2 may be changed according to the set image quality mode. Specifically, in the case of the first threshold, a value of “M” in Th1=Ave+Mσ is changed to change the position of Th1 in a luminance direction of the histogram. Further, in the case of the second threshold, a value of “N” in Th2=A+Nσ (M<N) is changed to change the position of Th2 in the luminance direction of the histogram.

For example, as shown in FIG. 13, when the values of M and N are increased according to the image quality mode to shift the first and second thresholds Th1 and Th2 to a high-luminance side, it is possible to emphasize sharpness of image quality in a dark environment to have image quality focusing on contrast feeling. On the other hand, when the first and second thresholds Th1 and Th2 are shifted to a low-luminance side, it is possible to have image quality focusing on brightness of a screen.

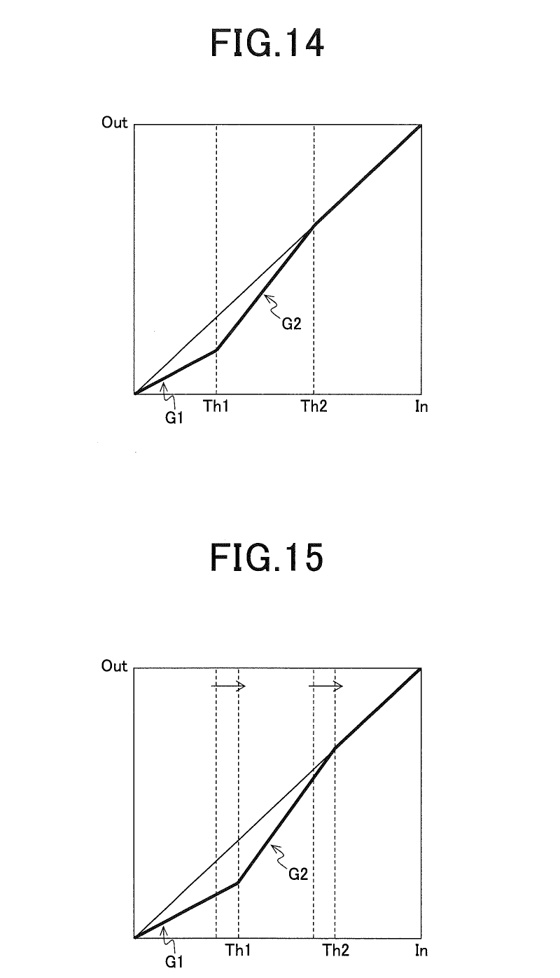

FIG. 14 is a diagram explaining an example of tone mapping that is changed according to an image quality mode, which is a diagram showing an example of tone mapping that is set in the case of the dynamic mode.

As described above, the mapping portion 13 sets the first gain G1 to an area smaller than the first threshold Th1 and sets the second gain G2 so as to linearly connect between Th1 and Th2 to perform tone mapping. At this time, the tone mapping is performed in accordance with the positions of the first threshold Th1 and the second threshold Th2 that are determined according to the image quality mode set to the image quality mode setting portion 19. In the dynamic mode, the first threshold Th1 and the second threshold Th2 are suppressed at a relatively low level (to the low-luminance side of the histogram) to provide a video focusing on brightness.

FIG. 15 is a diagram explaining another example of tone mapping that is changed according to an image quality mode, which is a diagram showing an example of tone mapping that is set in the case of the standard mode.

In the standard mode, both levels of the first threshold Th1 and the second threshold Th2 are made high compared to the dynamic mode focusing on brightness. That is, the first and second thresholds Th1 and Th2 are shifted to the high-luminance side of the histogram. Thereby, excessive dazzling on a display screen is suppressed as well as an image having sharpness is displayed in a standard viewing environment such as at home.

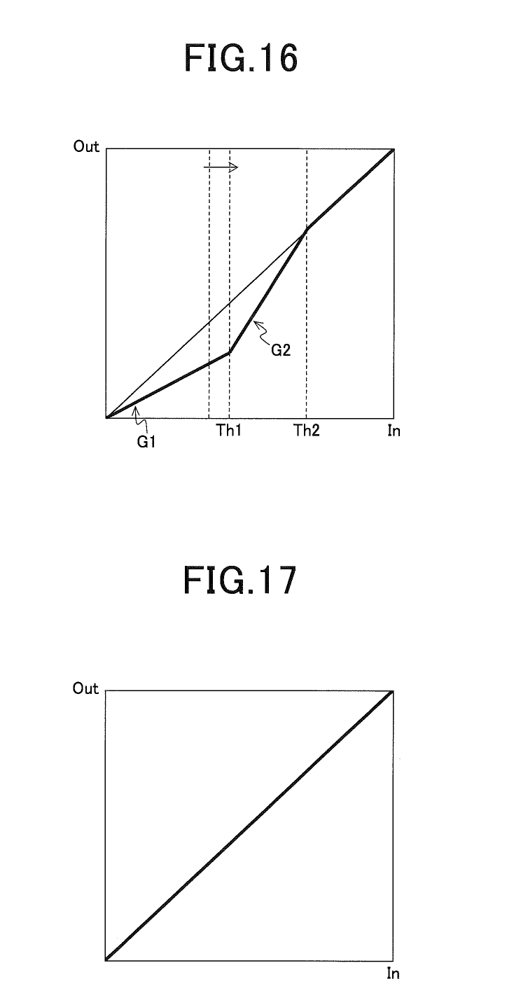

FIG. 16 is a diagram explaining still another example of tone mapping that is changed according to an image quality mode, which is a diagram showing an example of tone mapping that is set in the case of the movie mode.

In the movie mode, only the level of the first threshold Th1 is made much higher compared to the standard mode. That is, only Th1 is shifted to the high-luminance side of the histogram. Thereby, sharpness of image quality in a dark environment is emphasized so as to prevent fatigue due to dazzling from being caused.

FIG. 17 is a diagram explaining still another example of tone mapping that is changed according to an image quality mode, which is a diagram showing an example of tone mapping that is set in the case of the PC mode.

As described above, in the PC mode, luminance enhancement processing by detection of light emission is substantially turned off. Accordingly, an output tone with respect to an input tone has the same value also in tone mapping.

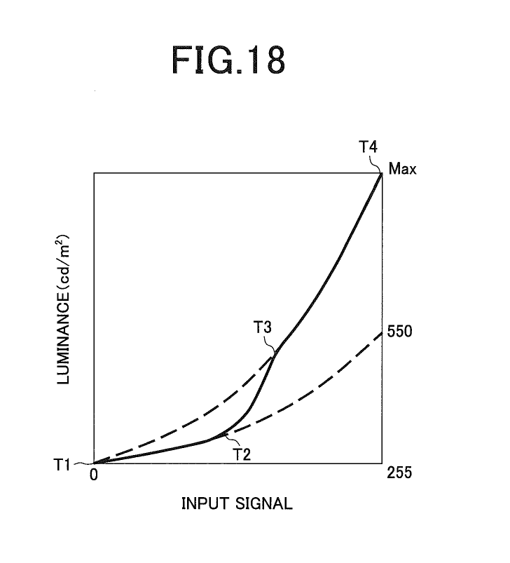

FIG. 18 is a diagram showing a state where screen luminance is enhanced by processing of the area-active-control/luminance-stretching portion 14. A horizontal axis is a tone value of an input video signal and a vertical axis is screen luminance (cd/m²) of the display portion 18.

T2 and T3 correspond to positions of tone values of the first and second thresholds Th1 and Th2 used in the light emission detecting portion 12, respectively. In an area not less than the second threshold Th2 detected by the light emission detecting portion 12 as described above, signal processing for reducing an output tone of a video signal according to a luminance stretch quantity of the backlight is not performed. As a result of this, the input video signal is displayed by being enhanced with a γ curve according to Max luminance determined by area active control from T3 to T4. For example, in a case where Max luminance is 1500 (cd/m²), when the input video signal has a maximum tone value (255), screen luminance is 1500 (cd/m²). The Max luminance in this case is Max luminance that is determined according to the average lighting rate determined based on the video signal and the set image quality mode.

On the other hand, in the case of an input tone value from T1 to T2, as described above, the first gain G1 is applied to the video signal so as to reduce an increment of screen luminance by luminance stretching of the backlight, so that the screen is displayed with the γ curve based on reference luminance. This is because an output value of the video signal is suppressed in a range smaller than the threshold Th1 (corresponding to T2) in response to a quantity of luminance stretching in the mapping portion 13 in accordance with Max luminance determined by the area-active-control/luminance-stretching portion 14. T2 to T3 has screen luminance shifted according to tone mapping of Th1 to Th2.

As Max luminance increases, there is a larger difference in a screen luminance direction between a curve based on reference luminance from T1 to T2 and a curve based on Max luminance from T3 to T4. As described above, the curve based on the reference luminance is a γ curve in which screen luminance of a maximum tone value becomes reference luminance when backlight luminance is not stretched (as an example, screen luminance of a maximum tone value is 550 cd/m²), and the curve based on Max luminance is a γ curve in which screen luminance of a maximum tone value becomes Max luminance determined by the area-active-control/luminance-stretching portion 14.

In this manner, screen luminance is controlled with the reference luminance while the input video signal is from 0 tone (T1) to T2. In the case of a dark video with a low tone, when being displayed with increased luminance, deterioration of quality such as reduction of contrast and black float is caused, so that luminance is suppressed by video signal processing only by a quantity of luminance stretching of the backlight so as not to increase the screen luminance.

Further, since a range where the input video signal is at T3 or more is a range that is regarded as emitting light, the video signal is maintained without being suppressed in a state where the backlight is stretched by luminance stretching. Thereby, the screen luminance is enhanced to allow display of a high-definition image having more feeling of brightness.

In this case, for example, when Max luminance is suppressed low in accordance with the image quality mode set to the image quality mode setting portion 19, a difference in the screen luminance direction between the curve based on reference luminance from T1 to T2 and the curve based on Max luminance from T3 to 14 becomes small. That is, as Max luminance that is determined according to the image quality mode set in the image quality mode setting portion 19 becomes small, the curve from T3 to T4 shifts to the low-luminance side. Further, the positions of T2 to T3 correspond to the positions of the first thresholds Th1 and the second threshold Th2 that change according to the set image quality mode, respectively. When the positions of T2 and T3 shift to the high-tone side of the input signal, display is performed with contrast feeling focused on. Note that, the γ curve from T1 to T2 does not need to conform to the reference luminance, and is able to be set by appropriately adjusting the gain G1, as long as having a level of giving a difference from an enhanced area of a light emitting part.

### Embodiment 2

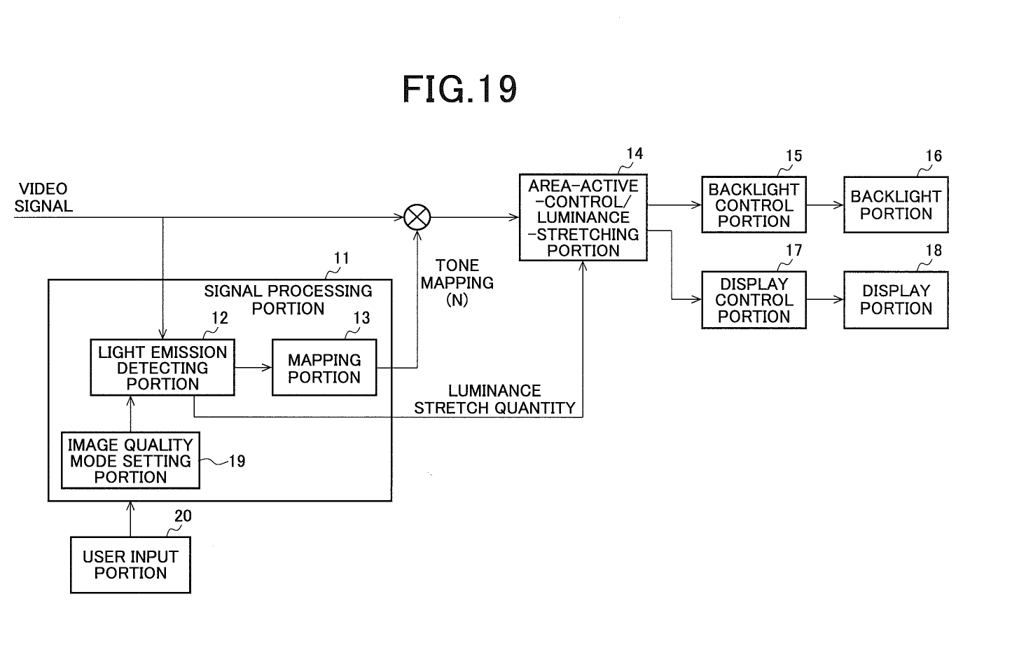

FIG. 19 is a diagram explaining a second embodiment of the video display device according to the present invention.

The second embodiment has the same configuration as the first embodiment, but, differently from the first embodiment, determines a luminance stretch quantity based on a detection result of the light emission detecting portion 12 and an image quality mode set to the image quality mode setting portion 19, without determining a value of Max luminance, which is used for performing tone mapping, by the area-active-control/luminance-stretching portion 14, and executes tone mapping based on the determined luminance stretch quantity. Accordingly, the mapping portion 13 of the signal processing portion 11 does not need to cause the area-active-control/luminance-stretching portion 14 to output a value of Max luminance by luminance stretching like the embodiment 1.

The image quality mode setting portion 19 sets the image quality mode of the video display device in accordance with operation of the user input portion 20 and the like, in the same manner as the embodiment 1. In the embodiment 2, information of the set image quality mode is output to the light emission detecting portion 12.

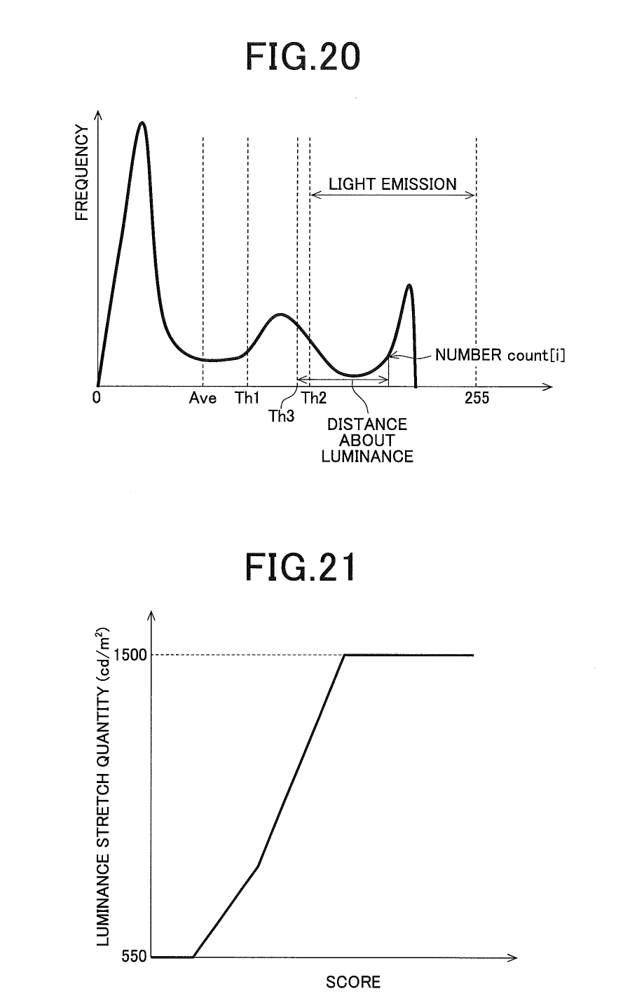

FIG. 20 shows an example of a Y histogram generated from a luminance signal Y of an input video signal. In the same manner as the embodiment 1, the light emission detecting portion 12 integrates the number of pixels for each luminance tone of pixels to generate a Y histogram for each frame of an input video signal, by using luminance as a feature quantity of a video. Then, an average value (Ave) and a standard deviation (σ) are calculated from the Y histogram, and two thresholds Th1 and Th2 are calculated by using them. In the same manner as the embodiment 1, the second threshold Th2 defines a light emitting boundary and a pixel not less than this threshold Th2 is regarded as a part that emits light in the Y histogram. As the feature quantity of a video, other feature quantity described below is able to be used, but luminance is set to be used here.

In the present embodiment, in addition to the first threshold Th1 and the second threshold Th2 of the embodiment 1, a third threshold Th3 is further set. The third threshold Th3 exists between Th1 and Th2 and is provided to detect a state of a pixel of a light emitting part.

The threshold Th3 may have the same value as Th2, but is provided having a large margin for a light emitting part having Th2 or more in order to facilitate processing.

Therefore, given is

Th3=Ave+Qσ(M<Q≦N) expression (5)

FIG. 21 is a diagram showing exemplary calculation of a luminance stretch quantity according to a pixel not less than the third threshold Th3. A horizontal axis indicates a score of a pixel value not less than the third threshold Th3, and a vertical axis indicates a luminance stretch quantity according to the score. The score corresponds to an example of an index associated with brightness according to the present invention.

The score shows a degree of brightness by being defined as [proportion of a pixel not less than a certain threshold]×[distance from the threshold (difference of luminance)] for counting the number of pixels of a pixel having a tone value larger than the third threshold Th3 to calculate a weighted distance from the threshold Th3, and, for example, is calculated by an expression (6) below:

$$\begin{matrix} [ Formula 1 ] & \\ Score = 1000 \times {\sum }_{i > Th 3}^{ } \{ ( count [ i ] \times ( {i}^{2} - {( Th 3 )}^{2} ) / ( Total Number of Pixels \times {( Th 3 )}^{2} ) \} & ( 6 )\end{matrix}$$

In the expression (6), count [i] is a count of the number of pixels with respect to a tone value i. Further, i²−(Thresh3)² indicates a distance as to luminance (difference of luminance) as shown in FIG. 20, and may adopt a distance from a threshold in lightness L* instead. Note that, this square represents luminance, which is actually 2.2th power. That is, when a value of a digital code is i, the luminance becomes i^{2.2}. At this time, the lightness L* becomes (i^{2.2})^{1/3}≈i. As a result of verification with an actual video display device, a difference from a threshold in the luminance is more effective than a difference from a threshold in the lightness and the like. Further, in the expression (6), the total number of pixels indicates a value obtained by counting the number of all pixels regardless of i>Th3. If such a calculation value is adopted as the score, when there are a lot of high-tone pixels away from Th3 in a light emitting part, the score becomes high. Furthermore, even when the number of pixels not less than Th3 is fixed, the score becomes higher when there are a lot of high-tone pixels.

Then, in the case of having a score in a certain level or higher, a luminance stretch quantity is set high to increase feeling of brightness by stretching a brilliant video having a high tone so as to have much higher luminance. In this example, in a part having a certain level or higher score, possible maximum screen luminance reached after luminance stretching is set to 1500 (cd/m²). Moreover, when the score is low, it is set so that a luminance stretch quantity becomes small as the score becomes small. Furthermore, the light emission detecting portion 12 changes a control curve that prescribes a relation between the score and the luminance stretch quantity according to the image quality mode set to the image quality mode setting portion 19. This luminance stretch quantity has the same concept as Max luminance of the first embodiment and is indicated by, for example, a value of backlight duty.

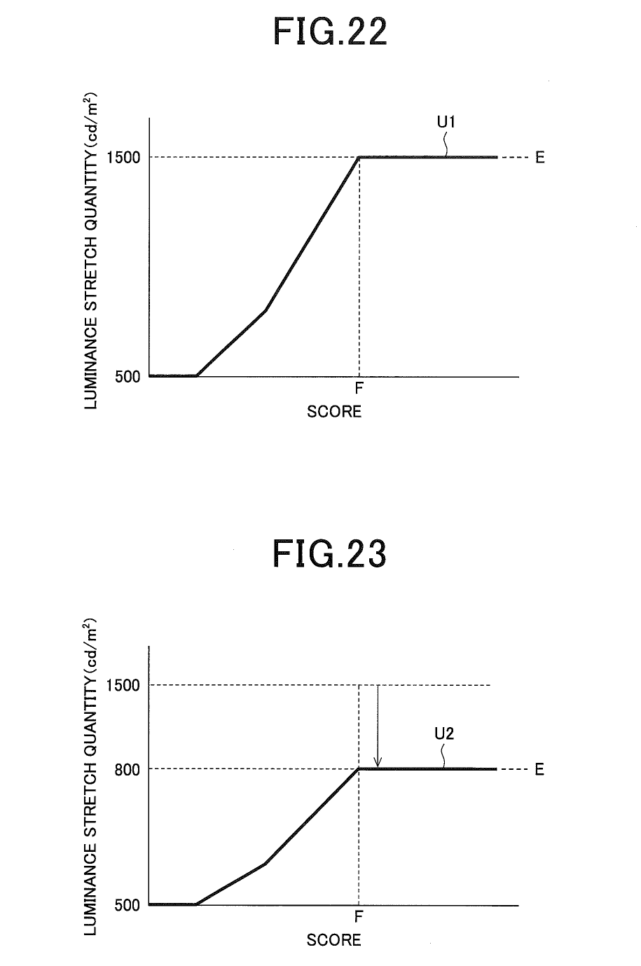

FIG. 22 is a diagram explaining exemplary setting of a control curve of a luminance stretch quantity, which shows exemplary control of a luminance stretch quantity when the image quality mode is the dynamic mode.

The light emission detecting portion 12 determines a luminance stretch quantity according to a score of a pixel value not less than the threshold Th3 as described above, and changes a control curve that defines a relation between the score and the luminance stretch quantity at this time according to setting information of the image quality mode output from the image quality mode setting portion 19.

In a control curve U1 of FIG. 22, it is set that a level of the maximum luminance stretch quantity in an entire range of the score is E and a score at a point where the luminance stretch quantity starts to be reduced from the level E of the maximum luminance stretch quantity as the score decreases is F.

In the control curve U1 in the dynamic mode of FIG. 22, the luminance stretch quantity E is set to a high luminance stretch quantity at about 1500 cd/m², and the score F is set at a relatively low value near an almost middle of the entire score. In the control curve U1, by setting the luminance stretch quantity E at a high level, an image becomes bright and brilliant. Further, the score F is set relatively low so as to provide an image focusing on brightness.

FIG. 23 is a diagram explaining another exemplary setting of a control curve of a luminance stretch quantity that is changed according to an image quality mode, which shows exemplary control of a luminance stretch quantity when the image quality mode is the dynamic mode. Ina control curve U2 of FIG. 23, the maximum luminance stretch quantity E is set low, for example, at 800 cd/m², compared to the dynamic mode. At this time, the level of the score F is set to a relatively low value near an almost middle of the entire score, in the same manner as the dynamic mode.

In the control curve U2 of the standard mode, by setting the maximum value of the luminance stretch quantity E at about 800 cd/m², the luminance stretch quantity is suppressed than the dynamic mode, to thereby suppress excessive dazzling on a display screen as well as display an image having sharpness in a standard viewing environment such as at home. Further, in the standard mode, the level of the score F is set to be equal to that of the dynamic mode, so that the luminance stretch quantity is maintained to be high to some extent even for an area of low and dark video, thus providing a video with standard brightness.

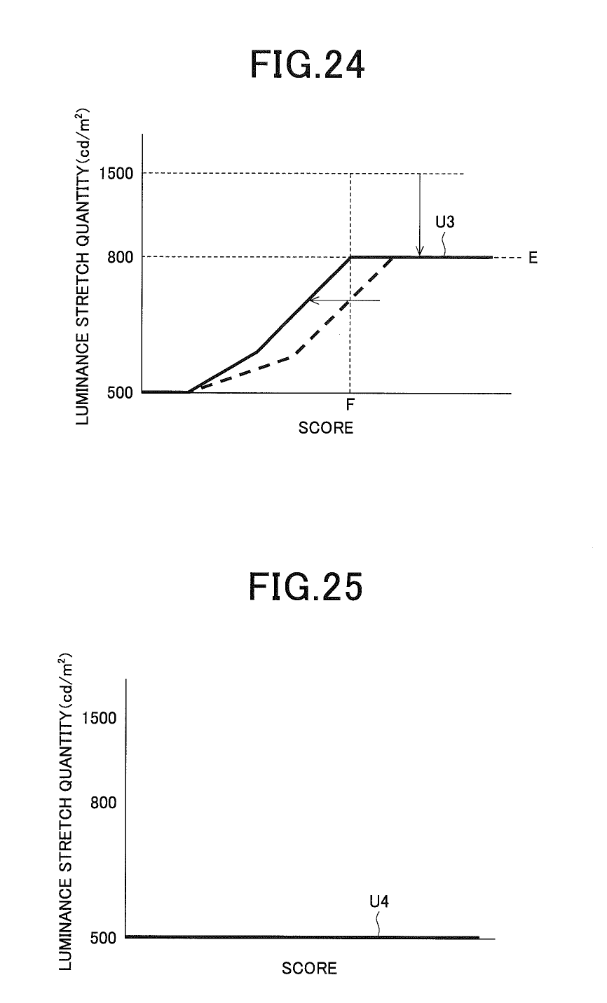

FIG. 24 is a diagram explaining still another exemplary setting of a control curve of a luminance stretch quantity that is changed according to an image quality mode, which shows exemplary control of a luminance stretch quantity when the image quality mode is the movie mode. In the control curve U3 of FIG. 24, the maximum luminance stretch quantity E is set low at about 800 cd/m² which is the same as the standard mode. Then, the level of the score F is set to a lower value than the dynamic mode and the standard mode.

Here, in the control curve U3 of the movie mode, by setting the maximum luminance stretch quantity E at a lower level than the dynamic mode, it is possible to reproduce a video by preventing feeling dazzling excessively when a movie content or the like is viewed carefully. In addition, by shifting the level of F to a low-score side compared to the standard mode, it is possible to reproduce a video by preventing feeling dazzling excessively when a movie content or the like is viewed carefully, as well as by focusing on feeling of brightness when there is a peak even though being dark in a divided area, that is, of a bright part having a relatively small area.

FIG. 25 is a diagram explaining still another exemplary setting of a control curve of a luminance stretch quantity that is changed according to an image quality mode, which shows exemplary control of a luminance stretch quantity when the image quality mode is the PC mode. In the case of the PC mode, in a control curve U4 that defines a relation between the score and the luminance stretch quantity, the luminance stretch quantity is fixed regardless of a value of the score. The level of the luminance stretch quantity at this time is set as a standard level of about 550 cd/m². That is, in the PC mode, luminance enhancement processing by detection of light emission is substantially turned off. The PC mode focuses on reproduction of faithfulness of a video, and therefore does not perform video processing by detecting a bright part of the video nor perform luminance stretching of the backlight so that an input video signal is to be reproduced faithfully.

Next, description will be given for an example of tone mapping that changes according to an image quality mode.

As described in the first embodiment above with reference to FIG. 13, in the present embodiment as well, the light emission detecting portion 12 integrates the number of pixels for each luminance tone to generate a Y histogram for each frame of an input video signal. Then, an average value (Ave) and a standard deviation (σ) are calculated from the Y histogram, and the second threshold Th2 that defines a light emitting boundary and the first threshold Th1 for suppressing incongruity in tones of an area smaller than Th2 and the like (Th1=Ave z+Mσ) are set.

At this time, a position of the first threshold Th1 and a position of the second threshold Th2 are changed according to the image quality mode set to the image quality mode setting portion 19. Alternatively, either the position of the first threshold Th1 or the second threshold Th2 may be changed according to the set image quality mode. Specifically, in the case of the first threshold, a value of “M” in Th1=Ave+Mσ is changed to change the position of Th1 in a luminance direction of the histogram. Further, in the case of the second threshold, a value of “N” in Th2=A+Nσ (M<N) is changed to change the position of Th2 in the luminance direction of the histogram. For example, when the values of M and N are increased according to the image quality mode to shift the first and second thresholds Th1 and Th2 to the high-luminance side, it is possible to emphasize sharpness of image quality in a dark environment to have image quality focusing on contrast feeling. On the other hand, when the first and second thresholds Th1 and Th2 are shifted to the low-luminance side, it is possible to have image quality focusing on brightness of a screen.

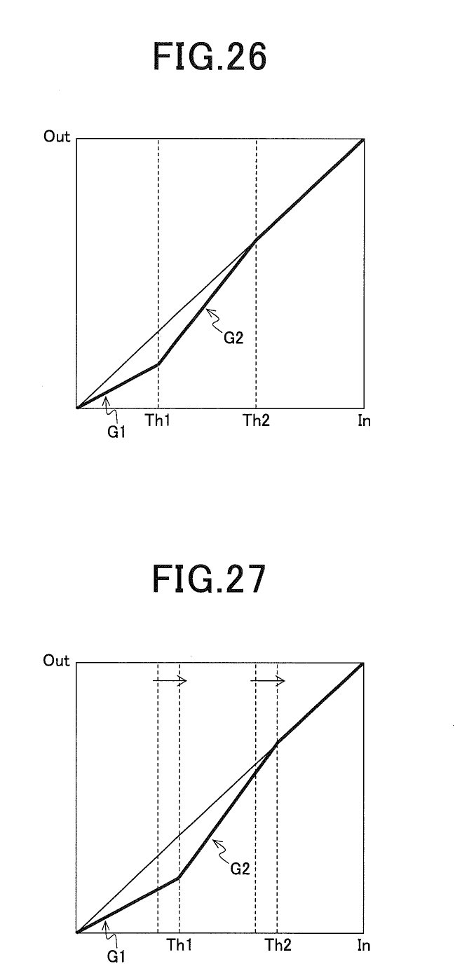

FIG. 26 is a diagram explaining an example of tone mapping that is changed according to an image quality mode, which is a diagram showing an example of tone mapping that is set in the case of the dynamic mode.

As described above, the mapping portion 13 sets the first gain G1 to an area smaller than the first threshold Th1 and sets the second gain G2 so as to linearly connect between Th1 and Th2 to perform tone mapping. At this time, the tone mapping is performed in accordance with the positions of the first threshold Th1 and the second threshold Th2 that are determined according to the image quality mode set to the image quality mode setting portion 19. In the dynamic mode, the first threshold Th1 and the second threshold Th2 are suppressed at a relatively low level (to the low-luminance side of the histogram) to provide a video focusing on brightness.

FIG. 27 is a diagram explaining another example of tone mapping that is changed according to an image quality mode, which is a diagram showing an example of tone mapping that is set in the case of the standard mode.

In the standard mode, both levels of the first threshold Th1 and the second threshold Th2 are made high compared to the dynamic mode focusing on brightness. That is, they are shifted to the high-luminance side of the histogram. Thereby, excessive dazzling on a display screen is suppressed as well as an image having sharpness is displayed in a standard viewing environment such as at home.

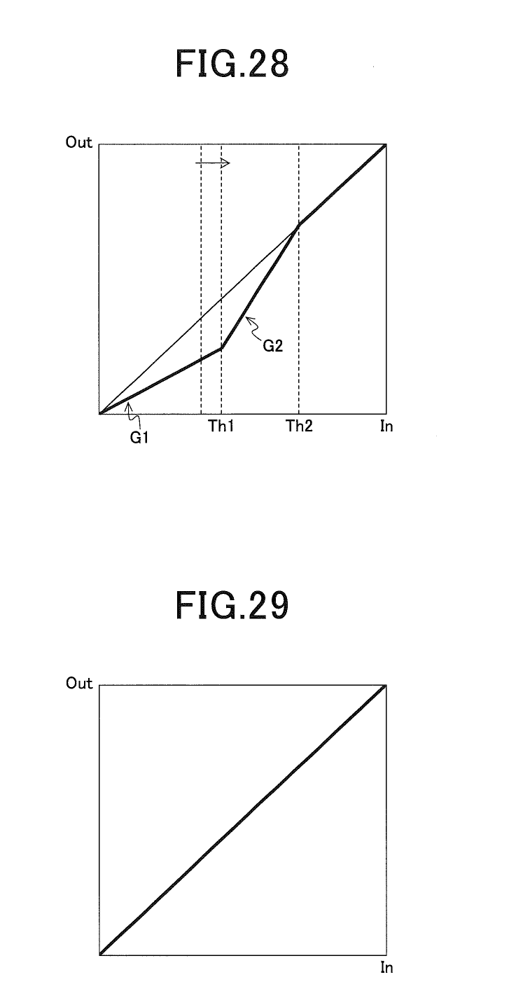

FIG. 28 is a diagram explaining still another example of tone mapping that is changed according to an image quality mode, which is a diagram showing an example of tone mapping that is set in the case of the movie mode.

In the movie mode, only the level of the first threshold Th1 is made much higher compared to the standard mode. That is, only Th1 is shifted to the high-luminance side of the histogram. Thereby, sharpness of image quality in a dark environment is emphasized so as to prevent fatigue due to dazzling from being caused.

FIG. 29 is a diagram explaining still another example of tone mapping that is changed according to an image quality mode, which is a diagram showing an example of tone mapping that is set in the case of the PC mode.

As described above, in the PC mode, luminance enhancement processing by detection of light emission is substantially turned off. Accordingly, an output tone with respect to an input tone has the same value also in tone mapping.

The tone mapping obtained by the above-described processing is applied to the input video signal and input to the area-active-control/luminance-stretching portion 14.

The processing in the area-active-control/luminance-stretching portion 14 is the same as the embodiment 1. However, the area-active-control/luminance-stretching portion 14 does not need to determine Max luminance from an average lighting rate of the backlight to be output to the signal processing portion like the embodiment 1, and to the contrary, stretches luminance of an LED of the backlight portion 16 based on the luminance stretch quantity output from the light emission detecting portion 12 of the signal processing portion 11.

That is, the area-active-control/luminance-stretching portion 14 divides a video into a predetermined plurality of areas to extract a maximum tone value of a video signal for each of the divided areas, and determines a lighting rate of an LED for each area according to the extracted maximum tone value. For example, for a dark area with a low maximum tone value, the lighting rate is decreased to reduce luminance of the backlight. Then, electricity powered to the entire backlight is increased according to the luminance stretch quantity output from the light emission detecting portion 12 in this state to entirely up luminance of the backlight. Thereby, a bright video that emits light becomes brighter and feeling of brightness is increased. Moreover, in a non-light emitting part, luminance corresponding to luminance stretching is reduced by video signal processing, resulting that only a light emitting part on a screen has higher luminance, so that a high-definition video with high contrast is able to be displayed. The relation between an input video signal and screen luminance is the same as FIG. 18 shown in the first embodiment.

### Embodiment 3

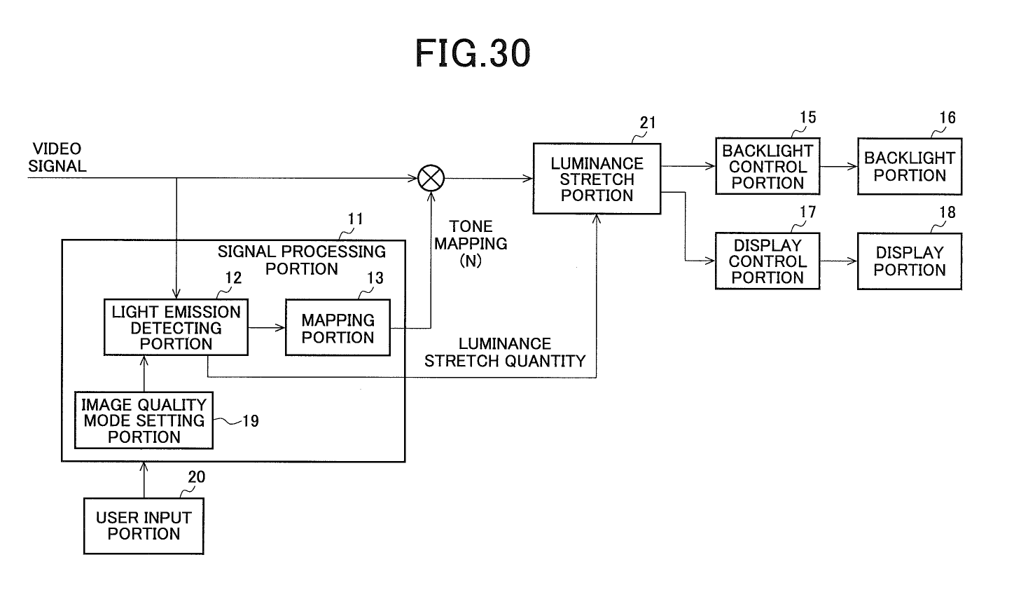

FIG. 30 is a diagram explaining still another embodiment of the video display device according to the present invention.

A third embodiment has the same configuration as the second embodiment for performing the same operation as the second embodiment, but, differently from the second embodiment, a luminance-stretching portion 21 stretches luminance of the backlight portion 16 based on a luminance stretch quantity output from the light emission detecting portion 12 of the signal processing portion 11 without performing area active control.

That is, the luminance-stretching portion 21 inputs a video signal to which tone mapping generated by the mapping portion 13 is applied to output control data displaying the video signal to the display control portion 17. At this time, processing by area active control is not performed. On the other hand, the entire backlight portion 16 is uniformly stretched based on the luminance stretch quantity output from the light emission detecting portion 12.

Thereby, a bright video that emits light becomes brighter and feeling of brightness is increased. Moreover, in a non-light emitting part, luminance corresponding to luminance stretching is reduced by video signal processing, resulting that luminance becomes high in a light emitting part on a screen, so that a high-definition video with high contrast is able to be displayed.

Operation for other components in the third embodiment is the same as the second embodiment, so that repetitive description will be omitted.

### (Other Feature Quantity)

In the above-described respective examples, the luminance Y is used as a feature quantity in processing for detecting a light emitting part by the light emission detecting portion 12 and a luminance histogram is generated to detect a light emitting part therefrom. As the feature quantity for generating the histogram, in addition to luminance, for example, a CMI (Color Mode Index) or Max RGB is able to be used.

The CMI is an index showing how bright a focused color is. Here, differently from luminance, the CMI shows brightness to which color information is also added. The CMI is defined by:

L*/L*modeboundary×100 expression (7)

The above-described L* is an index of relative brightness of a color, and the case of L*=100 provides lightness of the brightest white as an object color. In the above-described expression (7), L* is lightness of a focused color, and L*modeboundary is a lightness of a boundary appearing like emitting light with the same chromaticity as the focused color. Here, it is found that lightness is provided as L*modeboundary≈optimal color (brightest color of object colors). Lightness of a color provided as CMI=100 is referred to as a light emitting color boundary, and defined that light is emitted when exceeding CMI=100.

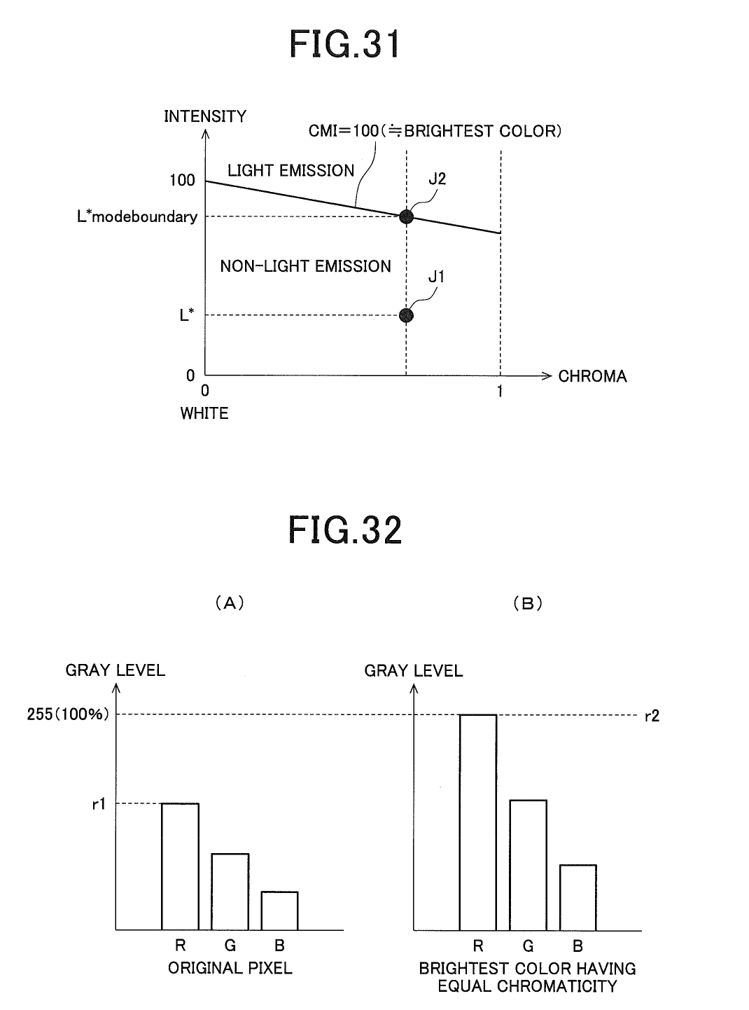

A method for calculating the CMI from a broadcast video signal to be displayed on the video display device will be described with reference to FIG. 31. A broadcast video signal is standardized to be transmitted based on the BT.709 standard. Therefore, first, RGB data of the broadcast video signal is converted into data of a tristimulus value XYZ using a conversion matrix for the BT.709. Then, the lightness L* is calculated using a conversion equation from Y. It is set that L* of the focused color is at a position J1 of FIG. 31. Chromaticity is then calculated from the converted XYZ to examine L* of an optimal color with the same chromaticity as the focused color (L*modeboundary) from known data of the optimal color. The position on FIG. 31 is J2.

From these values, the CMI is calculated using the above-described expression (7). The CMI is shown by a ratio of L* of a focused pixel to L* of an optimal color with the chromaticity thereof (L*modeboudary).

The CMI is obtained by the above-described method for each pixel of a video signal. With the standardized broadcast signal, all pixels take any one of the CMIs falling within a range 0 to 100. Then, for one frame of a video, a CMI histogram is created with a horizontal axis as a CMI and a vertical axis as frequency. Here, the average value Ave. and the standard deviation σ are calculated to set each threshold for detecting a light emitting part.

Further, in another example, a feature quantity is data having a maximum tone value of RGB data (Max RGB). Having two colors with the same chromaticity in a combination of RGB means the same as that a ratio of RGB is not changed. That is, processing for operating an optimal color with the same chromaticity in the CMI is processing for obtaining a combination of RGB having the largest tone of RGB data when the ratio of RGB data is not changed to be multiplied by a fixed number.

For example, it is set that a pixel having RGB data with a tone as shown in FIG. 32(A) is a focused pixel. When RGB data of the focused pixel is multiplied by a fixed number, a color when any of RGB is first saturated is the brightest color with the same chromaticity as an original pixel, as shown in FIG. 32(B). Then, when a tone of the focused pixel of the color which is first saturated (in this case, R) is r1, and a tone of R of an optimal color is r2, the value similar to the CMI is able to be obtained by:

r1/r2×100 expression (8)

The color which is first saturated when RGB is multiplied by a fixed number is a color having a maximum tone of RGB of the focused pixel.

The value by the above-described expression (8) is then calculated to create a histogram for each pixel. The average value Ave. and the standard deviation σ are calculated from this histogram to set each threshold so that a light emitting part is able to be detected or a quantity of black is able to be detected. The histogram at this time may be one for integrating the maximum tone values of RGB of pixels without being converted into values of 0 to 100 in accordance with the expression (8).

### EXPLANATIONS OF LETTERS OR NUMERALS

11 . . . signal processing portion, 12 . . . light emission detecting portion, 13 . . . mapping portion, 14 . . . area-active-control/luminance-stretching portion, 15 . . . backlight control portion, 16 . . . backlight portion, 17 . . . display control portion, 18 . . . display portion, 19 . . . image quality setting portion, 20 . . . user input portion, and 21 . . . luminance stretching portion.

1.-13. (canceled)

14. A video display device comprising: a display portion for displaying an input video signal; a light source for illuminating the display portion; and a control portion for controlling the display portion and the light source, wherein
the control portion stretches and increases luminance of the light source based on control curves that define a relation between an index associated with brightness calculated from the input video signal based on a predetermined condition and a luminance stretch quantity for stretching the luminance of the light source, as well as
detects a light emitting part that is regarded as a video emitting light based on a predetermined feature quantity of the input video signal and enhances display luminance of the light emitting part by reducing luminance of a video signal of a non-light emitting part excluding the light emitting part,
the video display device has an image quality mode setting portion for setting an image quality mode of the video display device, and
the control portion switches the control curves according to the image quality mode set to the image quality mode setting portion.

15. The video display device as defined in claim 14, wherein
the control portion divides an image by the input video signal into a plurality of areas, and changes a corresponding lighting rate of the light source for each of the areas based on a tone value of a video signal of the divided area,
the control curve is a control curve that defines a relation between an average lighting rate obtained by averaging the lighting rates corresponding to all areas and the luminance stretch quantity shown by possible maximum luminance on a screen of the display portion, and
the control portion uses the average lighting rate as the index associated with the brightness to stretch the luminance of the light source based on the maximum luminance defined in accordance with the average lighting rate.

16. The video display device as defined in claim 15, wherein
the control curve has a maximum value that the stretch quantity of the light source becomes the largest at a specific average lighting rate, and a value of the maximum value changes in accordance with the image quality mode.

17. The video display device as defined in claim 15, wherein
the control curve has a maximum value that the stretch quantity of the light source becomes the largest at a specific average lighting rate, and the maximum value changes in a direction where the average lighting rate increases or decreases in accordance with the image quality mode.

18. The video display device as defined in claim 14, wherein
the control curve is a control curve that defines a relation between a score obtained by counting the number of pixels by weighting brightness of each pixel and the luminance stretch quantity with respect to a video in a predetermined range including an area of the detected light emitting part, and
the control portion uses the score as the index associated with the brightness to stretch the luminance of the light source based on the score that is calculated from the input video signal.

19. The video display device as defined in claim 18, wherein
the control curve has a maximum value that the stretch quantity of the light source becomes the largest in a specific area of the score, and a value of the maximum value changes in accordance with the image quality mode.

20. The video display device as defined in claim 18, wherein
the control curve has a maximum value that the stretch quantity of the light source becomes the largest in a specific area including a highest value of the score, and a value of the score at a point where the luminance stretch quantity starts to be reduced from a level of the maximum value as the score decreases changes in accordance with the image quality mode.

21. The video display device as defined in claim 15, wherein
the control portion performs video processing for converting and outputting an input tone of the input video signal,
input/output characteristics that define a relation between the input tone and an output tone have a first threshold that is defined in an area of a non-light emitting part having a lower tone than a boundary of the light emitting part and the non-light emitting part, and a second threshold that defines the boundary of the light emitting part and the non-light emitting part, and
the control portion predefines a relation between a gain applied to the video signal and the luminance stretch quantity, and determines a gain by which the output tone is reduced with respect to the input tone of the input video signal in accordance with the luminance stretch quantity and applies the determined gain to an area having a lower tone than the first threshold to perform the video processing, and
in accordance with the image quality mode set to the image quality mode setting portion, changes the first threshold and/or the second threshold in the video processing.

22. The video display device as defined in claim 21, wherein
the control portion reduces an increment of display luminance of the display portion by stretching of the luminance of the light source through the video processing in a predetermined area having the low feature quantity.

23. A television receiving device including the video display device as defined in claim 14.
